(19) United States
(12) Patent Application Publication
(10) Pub. No.: US 2008/0027865 A1
(43) Pub. Date: Jan. 31, 2008

(54) Individual identifying/attribute authenticating system and individual identifying/attribute authenticating method

(75) Inventors: Akitoshi Usui, Tokyo (JP); Daisuke Ogawa, Tokyo (JP); Masahiro Sato, Tokyo (JP); Taiichi Matsuo, Tokyo (JP); Yoshiharu Araki, Kanagawa (JP); Toshiyuki Maeda, Tokyo (JP)

Correspondence Address: RABIN & Berdo, PC, 1101 14TH STREET, NW, SUITE 500, WASHINGTON, DC, 20005, US

(73) Assignees: OKI ELECTRIC INDUSTRY CO., LTD., Tokyo (JP); EBANK CORPORATION, Tokyo (JP)

(21) Appl. No.: 11/812,429

(22) Filed: Jun. 19, 2007

(30) Foreign Application Priority Data
Jul. 31, 2006 (JP) 2006-208559

(51) Int. Cl. H04L 9/00

(52) U.S. Cl. 705/50

(57) ABSTRACT

An individual identifying/attribute authenticating system includes a portable terminal possessed by a buyer of a good or service and an authenticating terminal set at a seller of the good or service. The portable terminal includes at least a component that generates an electronic signature by using a signature key and a component that transmits an electronic certificate and the electronic signature to the authenticating terminal. The authenticating terminal includes at least a component that judges whether or not the electronic signature is legitimate, a component that acquires an attribute information listed in the electronic certificate, in a case in which the electronic signature is legitimate, and a component that judges whether or not the attribute information satisfies a sales restricting condition of the good or service.

### CROSS-REFERENCE TO RELATED APPLICATION

This application claims priority under 35 USC 119 from Japanese Patent Application No. 2006-208559, the disclosure of which is incorporated by reference herein.

### BACKGROUND OF THE INVENTION

1. Field of the Invention

The present invention relates to an individual identifying/attribute authenticating system and an individual identifying/attribute authenticating method.

2. Description of the Related Art

Portable terminal devices, which are exemplified by cell phones, have started to be used as electronic money by adding the functions of a non-contact IC card (including reading and writing functions) to the portable terminal device and writing money information to the IC card portion. By incorporating the IC card itself into a portable terminal device (portable terminal) such as a cell phone or the like, the IC card information (the electronic money balance and the like) recorded at the IC card can be confirmed at a display by a display function and an application program executing function of the portable terminal. Further, personal application programs can be downloaded to the portable terminal from a cell phone network, and expanded, highly-convenient functions, such as depositing electronic money from a bank account or the like, can be added each time. The purchase of goods or services can be carried out by setting such a portable terminal near an account-settling terminal at a store (see, for example, Japanese Patent Application Laid-Open (JP-A) No. 2002-207951).

In payments using such a non-contact IC card or portable terminal in which a non-contact IC card is built-in, when selling goods which have age restrictions (e.g., tobacco products, alcohol, betting slips, and the like) or a good or service requiring identification of the individual (e.g., holding onto mail packages, reserved tickets, and the like), the seller requests that the buyer provide a document identifying that individual, such as a driver's license or health insurance card or the like. The buyer must carry out payment by cash or electronic money after the seller visually confirms the age or the name and address.

However, buyers do not necessarily always carry such certificates with them, and there are inconveniences such as the seller misses the opportunity to make a sale, or the buyer cannot purchase goods or services, or the like. Further, unmanned stores such as automatic vending machines or the like lack means for confirming the age or the individual. Moreover, even in cases in which it is only desired to confirm the age or the name of the buyer, other attribute information which essentially does not need to be disclosed (legal domicile, address, and the like), also must be disclosed to the seller, and there are concerns relating to leakage of personal information and violation of privacy due to this disclosure of personal information. In addition, if the seller wishes to retain proof of having confirmed the buyer's age, address or the like, work such as taking a copy of the certificate, or the like, is involved. Still further, when the seller retains proof by taking a copy of a license or the like, there are costs involved in carrying out strict storage and leakage prevention in order to protect this personal information.

### SUMMARY OF THE INVENTION

The present invention was developed in light of the above-described problems, and an object of the present invention is to provide a novel and improved individual identifying/attribute authenticating system and individual identifying/attribute authenticating method in which, at the time of an account settlement using electronic money, when selling goods or services requiring confirmation of age or identification of an individual, the seller can carry out confirmation of the attributes of the buyer and identification of the buyer, without the buyer providing a document such as a driver's license or the like.

An aspect of the present invention is an individual identifying/attribute authenticating system that includes a portable terminal possessed by a buyer of a good or service, and an authenticating terminal set at a seller of the good or service. The portable terminal includes: a storage component storing an electronic certificate, which lists attribute information of the buyer, and a signature key which are issued by an electronic authenticating service system; a component generating an electronic signature by using the signature key; and a component transmitting the electronic certificate and the electronic signature to the authenticating terminal. The authenticating terminal includes: a component receiving the electronic certificate and the electronic signature from the portable terminal; a component judging whether or not the electronic signature is legitimate, in accordance with whether or not the electronic signature was generated by the signature key corresponding to a signature verifying key listed in the electronic certificate; a component acquiring the attribute information listed in the electronic certificate, in a case in which the electronic signature is legitimate; and a component judging whether or not the attribute information satisfies a sales restricting condition of the good or service.

### BRIEF DESCRIPTION OF THE DRAWINGS

FIG. 1 is a schematic drawing of an electronic money account-settling system using a portable terminal relating to a first exemplary embodiment of the present invention.

FIG. 2 is a schematic drawing showing the portable terminal relating to the first exemplary embodiment of the present invention.

FIG. 3 is a schematic drawing showing data items of a memory relating to the first exemplary embodiment of the present invention.

FIG. 4 is an explanatory drawing showing data items of an electronic certificate relating to the first exemplary embodiment of the present invention.

FIG. 5 is an explanatory drawing showing an example of a subject relating to the first exemplary embodiment of the present invention.

FIG. 6 is an explanatory drawing showing examples of data items of a subject password table of the first exemplary embodiment of the present invention.

FIG. 7A is a flowchart showing processes of a seller confirming attribute information of an individual and selling a good or service by electronic money, by using an electronic money account-settling terminal.

FIG. 7B is a flowchart showing processes of a seller confirming attribute information of an individual and selling a good or service by electronic money, by using the electronic money account-settling terminal.

FIG. 8 is an explanatory drawing showing a data item of an electronic certificate relating to a second exemplary embodiment of the present invention.

FIG. 9 is an explanatory drawing showing a subject relating to the second exemplary embodiment of the present invention.

FIG. 10A is a flowchart showing processes of a seller confirming attribute information of an individual and selling a good or service by electronic money, by using an electronic money account-settling terminal.

FIG. 10B is a flowchart showing processes of a seller confirming attribute information of an individual and selling a good or service by electronic money, by using the electronic money account-settling terminal.

### DETAILED DESCRIPTION OF THE INVENTION

Exemplary embodiments of the present invention will be described hereinafter in detail with reference to the appended drawings. Note that, in the present specification and drawings, structural elements having substantially the same functions and structures are denoted by the same reference numerals and repeat description thereof is omitted.

### First Exemplary Embodiment

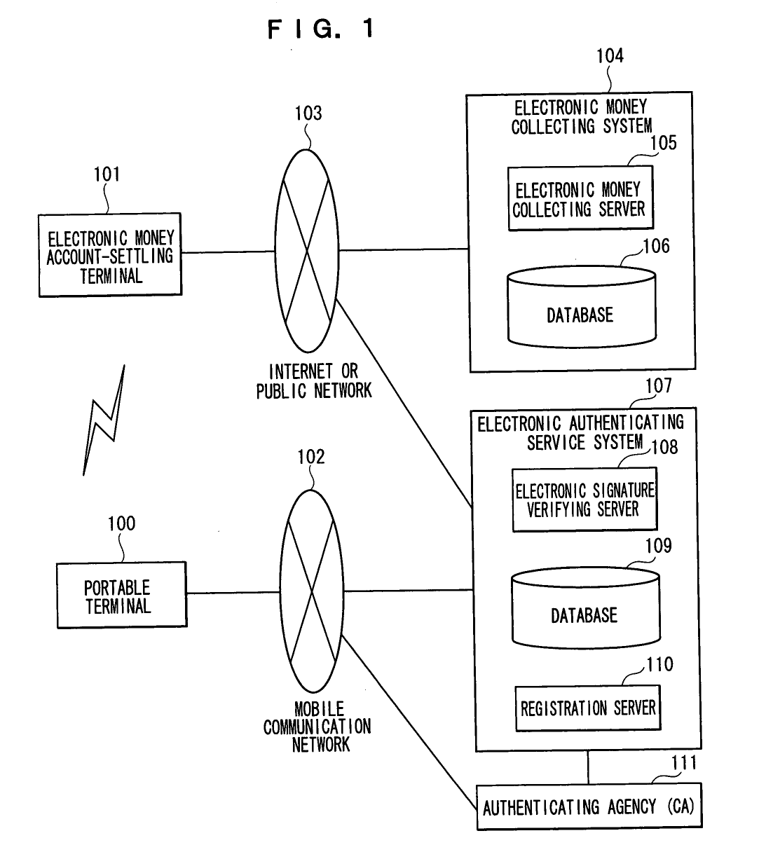

First, an electronic money account-settling system using a portable terminal relating to a first exemplary embodiment of the present invention will be described. FIG. 1 is a schematic drawing of an electronic money account-settling system using a portable terminal relating to the present exemplary embodiment.

A portable terminal 100, which is exemplified by a cell phone, is connected to a mobile communication network 102, and carries out voice conversation and data communication by using wireless technology. When carrying out electronic money account-settling by using the portable terminal 100, the electronic money account-settling is carried out with an electronic money account-settling terminal 101 which is set at the store or the like of a seller. A non-contact IC card which will be described later is built-into the portable terminal 100. Electronic money account-settling is carried out by exchanging electronic money information stored in the IC card and data in the electronic money account-settling terminal 101. Note that the portable terminal 100 is an example of a portable terminal, and the electronic money account-settling terminal 101 is an example of an authenticating terminal.

The seller inputs the charged amount and the like into the electronic money account-settling terminal 101 at the store of the seller. The buyer places the portable terminal 100 near a non-contact IC card reading section of the electronic money account-settling terminal 101, and completes the account-settling. Electronic money account-settling carries out account-settling between the portable terminal 100 and the electronic money account-settling terminal 101. The seller must replace the collected electronic money with cash. This is carried out by an electronic money collecting system 104 provided by an electronic money system provider. The electronic money account-settling terminal 101 and the electronic money collecting system 104 are connected by a public network such as a telephone line or the like, or online via an internet 103. The electronic money account-settling terminal 101 transmits the account-settlement history of electronic money, which is sales data, to an electronic money collecting server 105 of the electronic money collecting system 104. The electronic money system provider stores the sales data in a database 106, carries out adjustment computation such as the computing of a handling fee or the like, and transmits cash in the amount of the account settlement to the seller.

In the present exemplary embodiment, an authenticating service provider is added. This authenticating service provider provides, to an individual, the function of his/her personal information being certified by a third party. “Personal information” here means, for example, personal information such as name, age, date of birth, address, phone number, and the like. The authenticating service provider issues an electronic certificate using, for example, public key encryption or the like to the individual. In the present exemplary embodiment, the authenticating service provider issues an electronic certificate to the buyer. Further, the seller carries out identification of the individual who is the buyer and authentication of his/her attributes, such as age or the like, by using this electronic certificate. The use of electronic confirmation of an individual and authentication by using an electronic certificate has already advanced in, for example, the internet banking services of banks and the like, and technologies and services therefor have already been established.

By an electronic authenticating service system 107, an authenticating service provider provides the issuing of electronic certificates to buyers, and, to sellers, the two services of verifying electronic signatures and providing personal attribute information. The electronic authenticating service system 107 of the authenticating service provider is structured from a registration server 110, a database 109, and an electronic signature verifying server 108. An authenticating agency 111 issues an electronic certificate to the buyer under an instruction from the authenticating service provider.

When issuing an electronic certificate to an individual, the authenticating service provider carries out confirmation of that individual. Here, specific confirmation of an individual means, with respect to the aforementioned personal information such as the name and the like, the authenticating service provider confirming the original or a copy of a certificate issued by a public institution such as the driver's license, passport, or the like of the buyer. Further, with respect to the confirming of the current address, the authenticating service provider confirms the personal information of the individual for whom the electronic certificate is being issued, by sending, to that individual's residential address, a login ID or password for the buyer who is acquiring the electronic certificate or the like, by using postal mail such as registered mail or addressee restricted delivery mail. For example, when a bank sets up an account, the bank carries out confirmation of the individual who is applying to open the account by the individual providing a copy of or an original document identifying the individual and by confirming the address by using postal mail. Therefore, in a case in which a bank issues an electronic certificate, the bank can issue the electronic certificate without newly carrying out confirmation of that individual.

The buyer inputs the login ID or password that was mailed to him/her, from the portable terminal into a registration server 110 provided by the authenticating service provider, and carries out individual identification, and stores the electronic certificate issued from the authenticating agency 111 in the portable terminal.

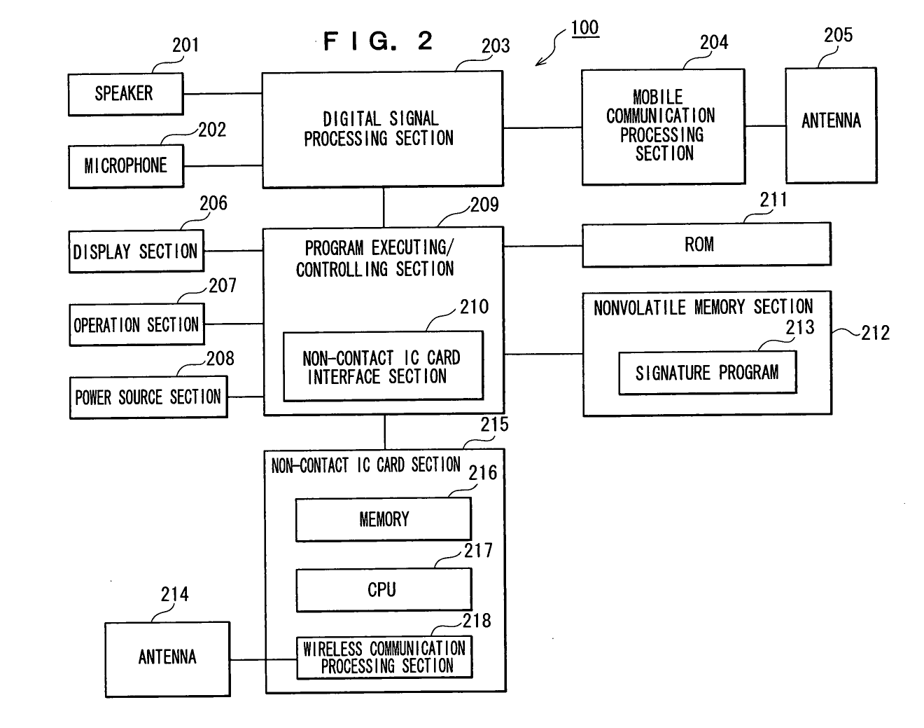

Next, the structure of the portable terminal relating to the present exemplary embodiment will be described by using FIG. 2. FIG. 2 is a schematic drawing showing the portable terminal relating to the present exemplary embodiment. The portable terminal 100 which is exemplified by a cell phone has, as voice conversation functions of a telephone, parts for voice input and output which are a speaker 201 and a microphone 202, a digital signal processing section 203 converting an analog voice into a digital signal and vice-versa, a mobile communication processing section 204 for carrying out mobile communication, and an antenna 205 for communicating with a base station or the like for mobile communication. Further, the aforementioned digital signal processing section 203 and mobile communication processing section 204 also have data communication functions, and have functions of carrying out data communication with servers on the internet in accordance with a data communication protocol such as TCP or the like, and, in order to use these data communication functions, the portable terminal has Web browser or email functions.

Further, the portable terminal 100 has a display section 206 such as a liquid crystal display or the like, and input/output functions of an operation section 207 which is formed from a keyboard or buttons or the like. The incorporated programs, such as the Web browser, email, and the like, are stored in a read only memory (ROM) 211. The portable terminal 100 has the function of downloading executable files of additional application programs by the data communication function of the portable terminal 100, and storing them in a nonvolatile memory section 212. These application programs are executed by a program executing/controlling section 209, and display images on the display section 206 and accept character input from the operation section 207.

Further, a non-contact IC card section 215 which is used in electronic money account-settling is built-into the portable terminal 100. The non-contact IC card section 215 is structured by: an antenna 214 for near wireless communication; a wireless communication processing section 218 which controls the wireless communication; a CPU 217 which is for executing an account-settling application of electronic money or the like, and cooperating with a non-contact IC card interface section 210 of the portable terminal 100, and cooperating with applications on the portable terminal 100; and a memory 216 which stores an electronic money writing program, the electronic money balance, and the account-settlement history. Here, near wireless communication is an example of a non-contact communication method, and the memory 216 is an example of a storage component. The non-contact IC card section 215 can cooperate with the applications of the portable terminal 100 via the non-contact IC card interface section 210. Specifically, a balance inquiry application of the portable terminal 100 can display, on the display section 206, the electronic money balance or the account-settlement history which are on the non-contact IC card section 215.

Further, a setup is provided which can provide various applications when the non-contact IC card section 215 is brought near the electronic money account-settling terminal 101, such as data of the electronic money account-settling terminal 101 can be transmitted to the program executing/controlling section 209. A signature key for an electronic signature and an electronic certificate issued by the electronic authenticating service system 107 are stored in the memory 216 of the non-contact IC card section 215. Or, the storage location may be on the nonvolatile memory section 212. A signature program 213, which is an application program which generates an electronic signature in accordance with the signature key on the non-contact IC card section 215, is stored on the nonvolatile memory section 212.

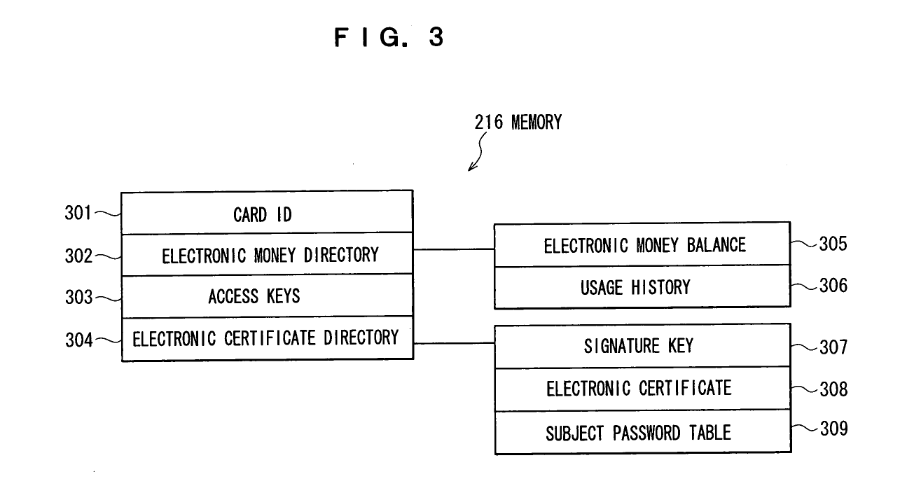

Next, data items of the memory 216 on the non-contact IC card section 215 will be described by using FIG. 3. FIG. 3 is a schematic drawing showing data items of the memory relating to the present exemplary embodiment. In the same way as existing IC card memories, the memory 216 differentiates between individual IC cards by a card ID 301. The memory 216 of the non-contact IC card section 215 is divided into directories and data storage regions. Each directory is protected by an access key 303, and is contrived such that data of that directory cannot be read or written unless the legitimate access key 303 is inputted. The directories protect important data on the non-contact IC card section 215. Information relating to electronic money is stored in two data regions of an electronic money directory 302. One region is an electronic money balance 305, and the second is a usage history 306. An electronic certificate directory 304 is structured from three regions. One stores a signature key 307 of a public key encryption system which is a certification key. The second is an electronic certificate 308 issued by the electronic authenticating service system 107, and the third is a subject password table 309.

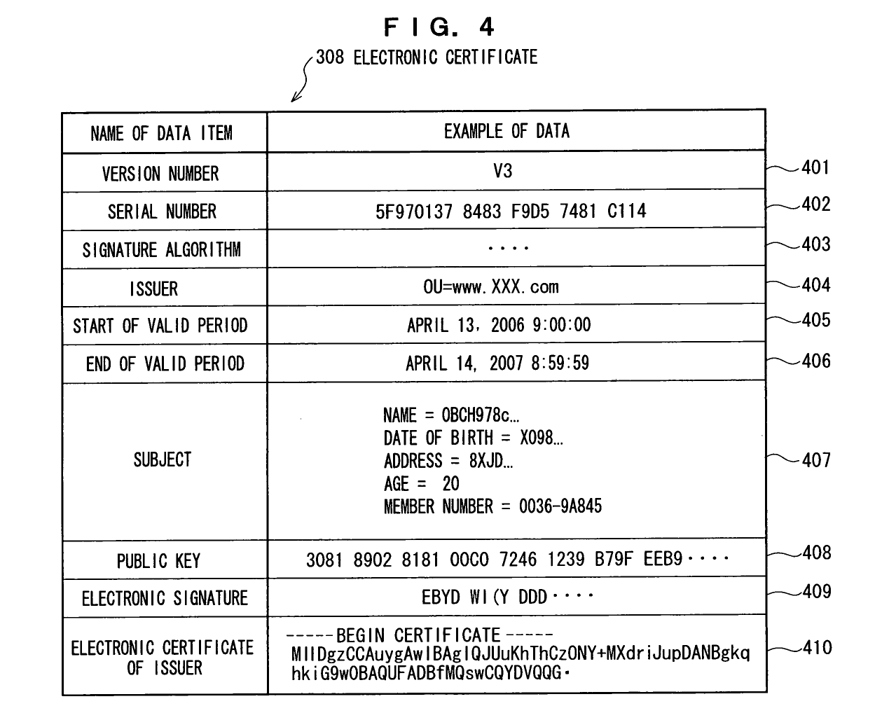

Next, the structure of the electronic certificate 308 will be described by using FIG. 4. FIG. 4 is an explanatory drawing showing data items of the electronic certificate relating to the present exemplary embodiment. Exemplary data items of the form of the electronic certificate 308 are: a version number 401 showing the version of the form of the certificate; a serial number 402 uniquely identifying the electronic certificate 308; a signature algorithm 403 used by the issuer of the electronic certificate 308; the issuer 404 which identifies the authenticating agency 111 issuing the electronic certificate 308; a start 405 of the valid period of the electronic certificate 308; an end 406 of the valid period; a subject 407 for identifying the party for whom the electronic certificate 308 is issued; a public key 408 of the buyer; an electronic signature 409 which the authenticating agency 111 carries out for the aforementioned information of the version number 401, the serial number 402, the signature algorithm 403, the issuer 404, the start 405 of the valid period, the end 406 of the valid period, the subject 407, and the public key 408; and an electronic certificate 410 of the issuer. From the electronic signature 409 and the electronic certificate 410 of the issuer, it can be confirmed whether or not the electronic certificate 308 is authentic. Accordingly, the seller can electronically confirm whether or not the version number 401, the serial number 402, the signature algorithm 403, the issuer 404, the start 405 of the valid period, the end 406 of the valid period, the subject 407, and the public key 408 have been altered from those issued by the authenticating agency 111.

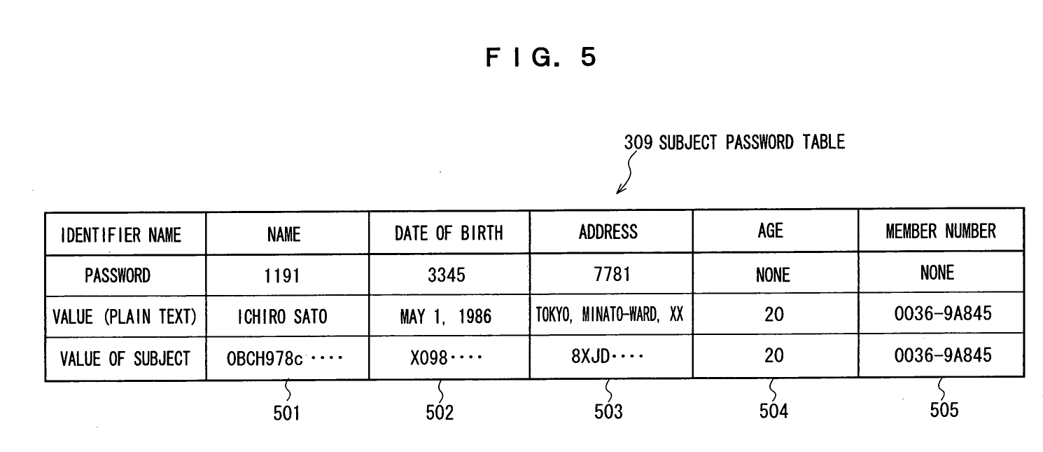

Next, an example of the subject 407 will be described by using FIG. 5. FIG. 5 is an explanatory drawing showing an example of the subject relating to the present exemplary embodiment. Attribute information of the buyer, which has been subjected to confirmation of the individual by an authenticating service provider, is stored in the subject 407 of the electronic certificate 308 in the present exemplary embodiment. However, although the subject 407 of the electronic certificate 308 cannot be altered by an ill-intended third party due to the electronic signature 409 of the authenticating agency 111, the buyer can, at the time of receiving the electronic certificate 308, refer to the information of the subject 407 in plain text. Namely, in a case in which attribute information such as name, date of birth and the like which are personal information are stored in the subject 407, all of the attribute information recorded in the subject 407 can be referred to by the buyer. Therefore, in the present exemplary embodiment, encrypted attribute information is recorded in the subject 407 by encrypting by a password. Specifically, a value “0BCH978c . . . ”, which encrypts the name “Ichiro Sato” by password 1191, is stored in “name” 501 which is an identifier name of the subject 407. Similarly, date of birth 502 and address 503 are stored in the subject 407 in encrypted forms. Attribute information, for which there is little problem if it is disclosed as information identifying the individual, such as age 504, member number 505, and the like, is listed in the subject 407 of the electronic certificate 308 in plain text as is without a password.

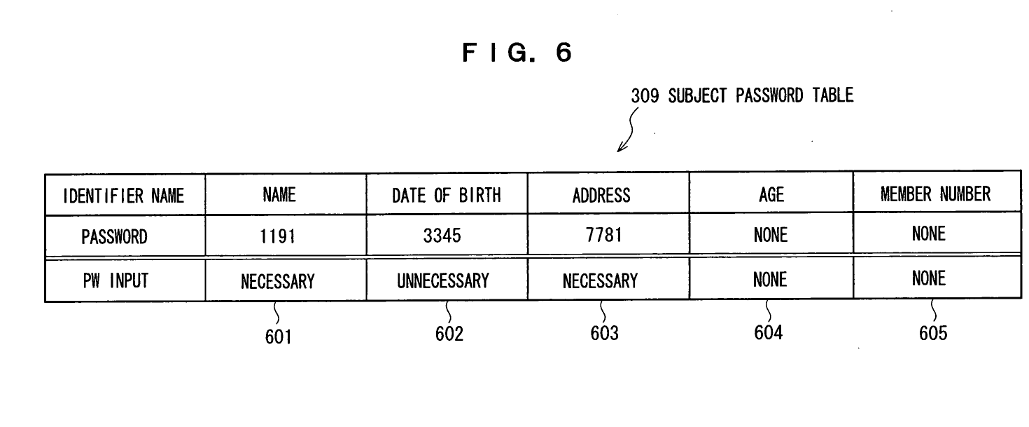

These attribute information within the subject 407 can be encrypted and stored. However, in the present exemplary embodiment, the buyer can set whether or not a password must be inputted from the operation section 207 of the portable terminal 100 when respective attribute items are to be disclosed to a seller. In order to realize these functions, the subject password table 309 is held in the memory 216 on the non-contact IC card section 215. This will be explained by using FIG. 6.

The subject password table relating to the present exemplary embodiment will be described next. FIG. 6 is an explanatory drawing showing examples of data items of the subject password table 309 of the present exemplary embodiment. The subject password table 309 is structured from three data items which are identifier name, password, and PW (password) input. The password is used in two ways. The first is that the password is used as a password for encrypting and decrypting the attribute information. Specifically, as described by using FIG. 5, the “name” attribute is encrypted in a form which can be decrypted by the password “1191”, and the encrypted subject “0BCH978c . . . ” is stored as the subject of the certificate. The second way the password is used is for making it such that the attribute information cannot be transmitted unless the buyer inputs the password from the operation section 207 of the portable terminal 100. The password is used in order for others to not be able to refer to the name, address, and the like if the portable terminal 100 is dropped or lost, and in order for the name, address, and the like to not be disclosed to the seller at the time of account settlement. The final data item “PW input” assumes any of three values which are necessary, unnecessary, or none. “Necessary” shows that password input by the buyer is needed, “unnecessary” means that the password is transmitted to the seller without password input by the buyer, and “none” means that no password exists and the attribute is stored in the subject in plain text without being encrypted.

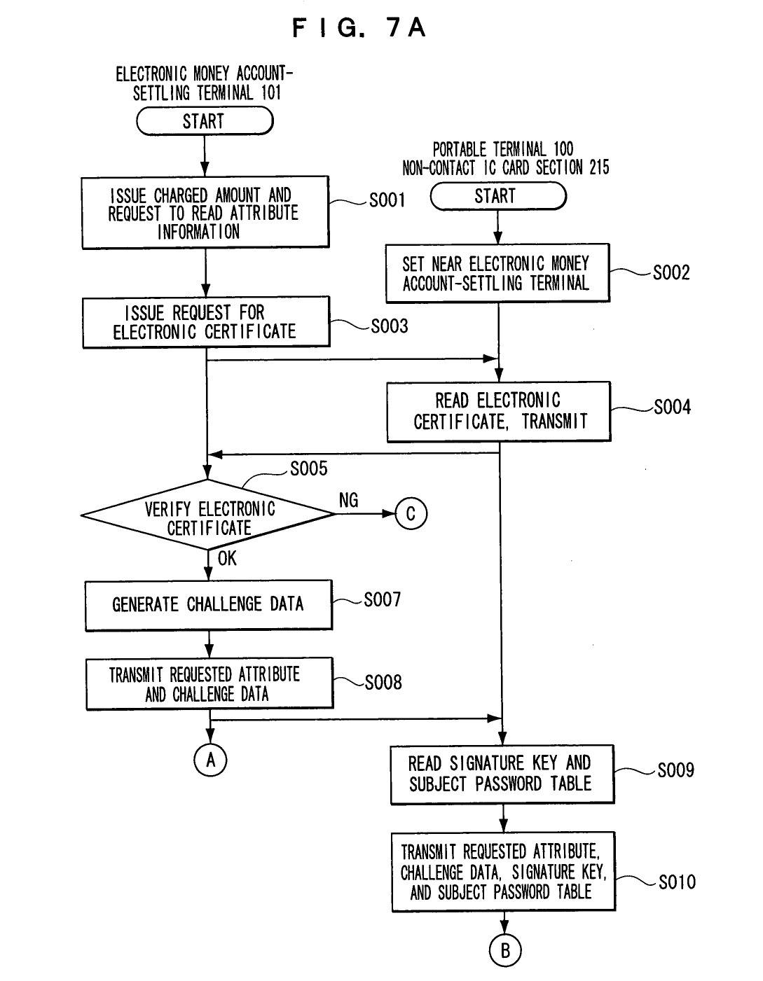

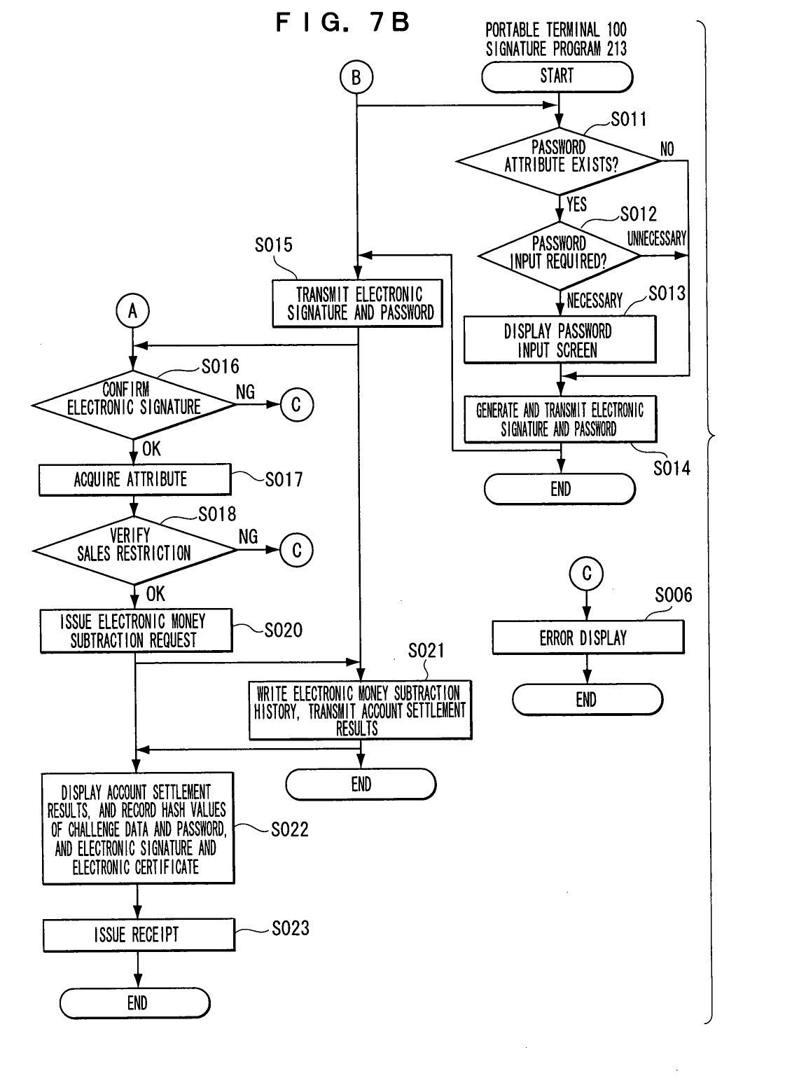

Next, the processes which carry out individual identification and attribute authentication at the time of electronic money account settlement will be described by using FIGS. 7A and 7B. FIGS. 7A and 7B are a flowchart showing the processes of a seller confirming the attribute information (name, age, address, and the like) of an individual and selling a good or service by electronic money, by using the electronic money account-settling terminal 101.

The transmission and receipt of information, the confirmation of attribute information, and account settling are carried out among the electronic money account-settling terminal 101, the portable terminal 100, and the non-contact IC card section 215 and the signature program 213 within the portable terminal 100.

The seller operates the electronic money account-settling terminal 101, and inputs, to the electronic money account-settling terminal 101, the charged amount and a request for the necessary attribute information (e.g., date of birth, name) (step S001). The buyer sets the portable terminal 100 near the electronic money account-settling terminal 101 (step S002). Due to the portable terminal 100 being set near to the electronic money account-settling terminal 101, the electronic money account-settling terminal 101 issues an electronic certificate request to the portable terminal 100 (step S003). The non-contact IC card section 215 which receives the request reads, from the memory 216, the electronic certificate 308 stored in the memory 216, and transmits the electronic certificate 308 to the electronic money account-settling terminal 101 (step S004). By using the signature verification key of the authenticating agency 111, the electronic money account-settling terminal 101 confirms that the received electronic certificate 308 is within the valid period, and that it is the electronic certificate 308 which that credit agency 111 has formally issued (step S005). If the electronic certificate 308 is legitimate, the electronic money account-settling terminal 101 continues the processing to next step S007, whereas if the electronic certificate 308 is not legitimate, the electronic money account-settling terminal 101 displays an error screen and terminates the account settlement (step S006).

Next, the electronic money account-settling terminal 101 generates challenge data. Specifically, a character string which is changed for each account settlement, such as the time of the account settlement or the like, is generated (step S007). The electronic money account-settling terminal 101 transmits the challenge data and the requested attribute to the non-contact IC card section 215 (step S008). The non-contact IC card section 215 which receives the information reads the signature key 306 and the subject password table 309 on the memory 216 (step S009). The non-contact IC card section 215 transmits, to the signature program 213, the requested attribute, the challenge data, the signature key 307, and the subject password table 309 (step S010). The signature program 213 compares the subject password table 309 and the requested attribute (e.g., date of birth), and reads the data of the password attribute of the identifier name “date of birth” in the subject password table 309, and advances processing to step S014 if there is no password (i.e., if “none”), and advances processing to step S012 if a password exists (step S011).

Then, the signature program 213 reads-out the data of the password input attribute in the subject password table 309, and if it is “necessary”, advances processing to step S013, and, if it is “unnecessary”, advances processing to step S014 (step S012). If password input is necessary, the signature program 213 displays the identifier name of the attribute (e.g., date of birth) and a password input screen on the display device of the portable terminal 100, and the buyer inputs the corresponding password (step S013). Next, by using the signature key 307, the signature program 213 generates an electronic signature for the challenge data and the password of that attribute of the subject password table 309, and transmits the password the buyer inputted in S013 and the electronic signature to the non-contact IC card section 215 (step S014). The non-contact IC card section 215 transmits the password the buyer inputted in S013 and the electronic signature to the electronic money account-settling terminal 101 (step S015). If no password exists, a null character string is transmitted as the password. The electronic money account-settling terminal 101 confirms the electronic signature by using the electronic signature, the electronic certificate, the challenge data, and the password (step S016). By confirming the electronic signature, the electronic money account-settling terminal 101 can confirm that this is a buyer who has a legitimate signature key corresponding to the received electronic certificate. Owing to this setup, the impropriety of an ill-intended third party using another's electronic certificate can be sensed. Further, even if the buyer inputs an incorrect password, there is an error in the electronic signature verification, and it can be sensed that the password is incorrect. If the electronic signature is legitimate, the electronic money account-settling terminal 101 advances the processing on to step S017, and if the electronic signature is not legitimate, the electronic money account-settling terminal 101 displays an error message and ends the account settlement (step S006). The electronic money account-settling terminal 101 reads-out the subject 407 of the electronic certificate 308, and decrypts the corresponding attribute data (e.g., date of birth) by using the received password. If the password is an empty character string at this time, decryption processing is not carried out, and the subject 407 which is read is used as the attribute data as is (step S017).

The electronic money account-settling terminal 101 verifies the restrictions on the sale on the basis of the decrypted attribute data. Specifically, in the case of a sale which is limited to those who are 20 years of age or older, from the attribute data of the date of birth and the current date, it is computed and verified that the buyer is 20 or older (step S018). The electronic money account-settling terminal 101 displays the results of verification of the sales restrictions and the attribute information (the computed age, or the name and address), and if the sale is permissible, advances the processing on to step S020. If the sale is not permitted, the electronic money account-settling terminal 101 displays an error message and ends the account settlement (step S006). Next, the electronic money account-settling terminal 101 issues, to the non-contact IC card section 215, an electronic money subtracting instruction for the charged amount inputted in step S001 (step S020). The non-contact IC card section 215 carries out subtraction processing of the electronic money, updates the electronic money balance 305 and the usage history 306, and transmits the account settlement results to the electronic money account-settling terminal 101 (step S021). The electronic money account-settling terminal 101 displays the account settlement results on the screen, and records, in a secondary storage device, the hash values of the challenge data and password, and the electronic signature and electronic certificate (step S022). Finally, the electronic money account-settling terminal 101 issues a receipt and ends the account settlement (step S023).

After the account settlement, the seller can prove that the electronic signature was issued from a legitimate buyer, by using the challenge data, the hash values of the challenge data and the password, the electronic signature, and the electronic certificate which were recorded in step S022. In this way, after the account settlement, the seller can electronically prove to a third party whether or not the seller truly carried out individual identification, and there is no need for the seller to retain attributes other than those which were confirmed.

### Second Exemplary Embodiment

In the above-described first exemplary embodiment of the present invention, description is given of a system in which attribute information of the individual is recorded in the subject 407 of the electronic certificate 308. A second exemplary embodiment of the present invention is a system in which only a number which identifies the individual is recorded in the subject of the electronic certificate, a network is connected from the seller to the authenticating service provider, and the actual attribute data is acquired at the point in time of the account settlement. In accordance with this system, there are the advantages that there is no need to record the attribute information of the individual in the subject, protection of personal information is facilitated, and the latest attribute data can be acquired for attributes which have the possibility of being changed, such as the address or the like.

The structure of the present exemplary embodiment is the same as the structure of the first exemplary embodiment of the present invention described by using FIG. 1. Further, the portable terminal which is used also is the same as the portable terminal shown in FIG. 2. The data items of the non-contact IC card section also are the same as those in FIG. 3. The differences between the first exemplary embodiment and the second exemplary embodiment are the electronic certificate 308 and the subject password table 309.

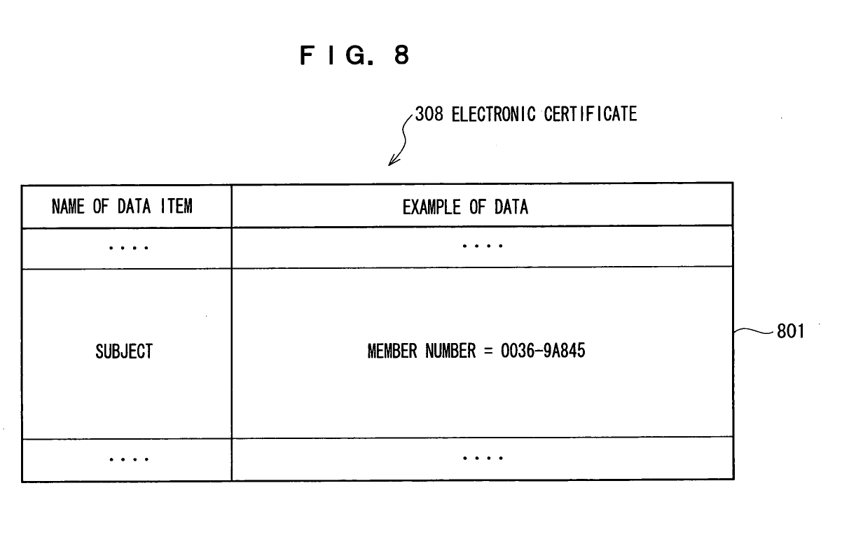

The structure of the electronic certificate 308 of the present exemplary embodiment will be described by using FIG. 8. FIG. 8 is an explanatory drawing showing the data item of the electronic certificate relating to the present exemplary embodiment. What is different from the first exemplary embodiment is the items of a subject 801. Namely, in the first exemplary embodiment, the subject 407 is plural data such as the name, date of birth and the like, whereas, in the present exemplary embodiment, there is only a number, such as a member number or the like for example, for the authenticating service provider to identify the individual.

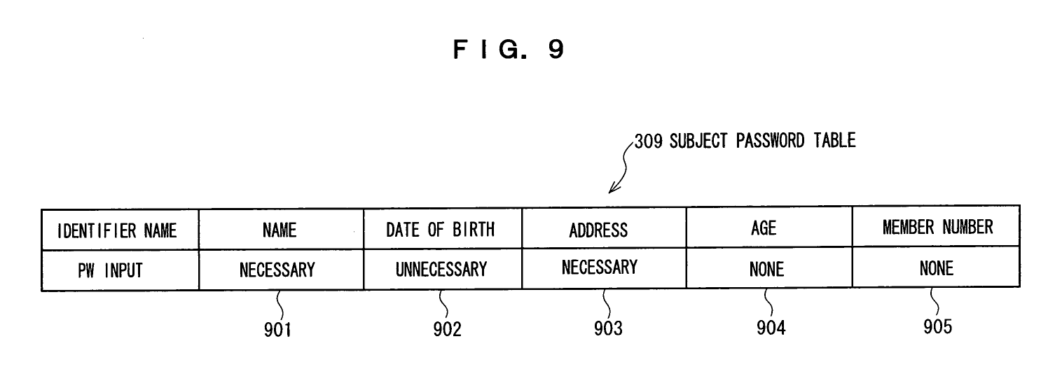

The subject password table 309 of the present exemplary embodiment will be described next by using FIG. 9. FIG. 9 is an explanatory drawing showing the subject relating to the present exemplary embodiment. In the present exemplary embodiment, the subject password table 309 is only the items of identifier name of the attribute and PW (password) input. The values of the identifier name and the PW input are the same as in the first exemplary embodiment. In the present exemplary embodiment, in the same way as in the first exemplary embodiment, the buyer can set in advance whether or not password input is necessary at the time of disclosing his/her own attribute information in advance.

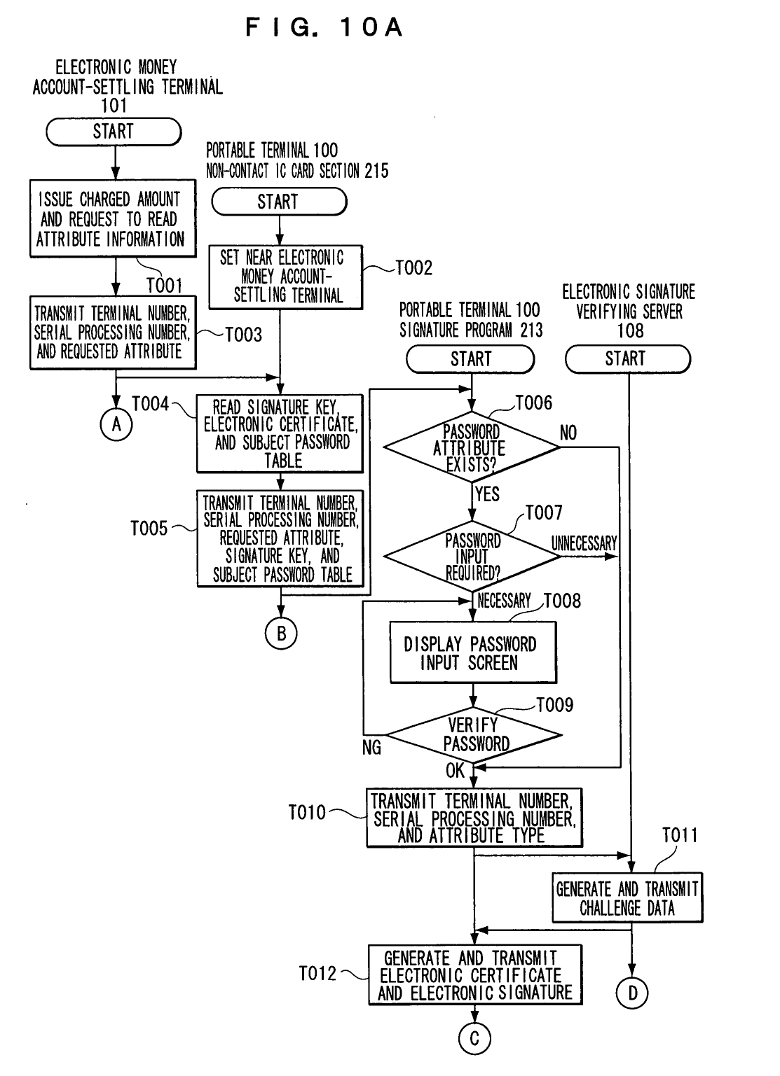

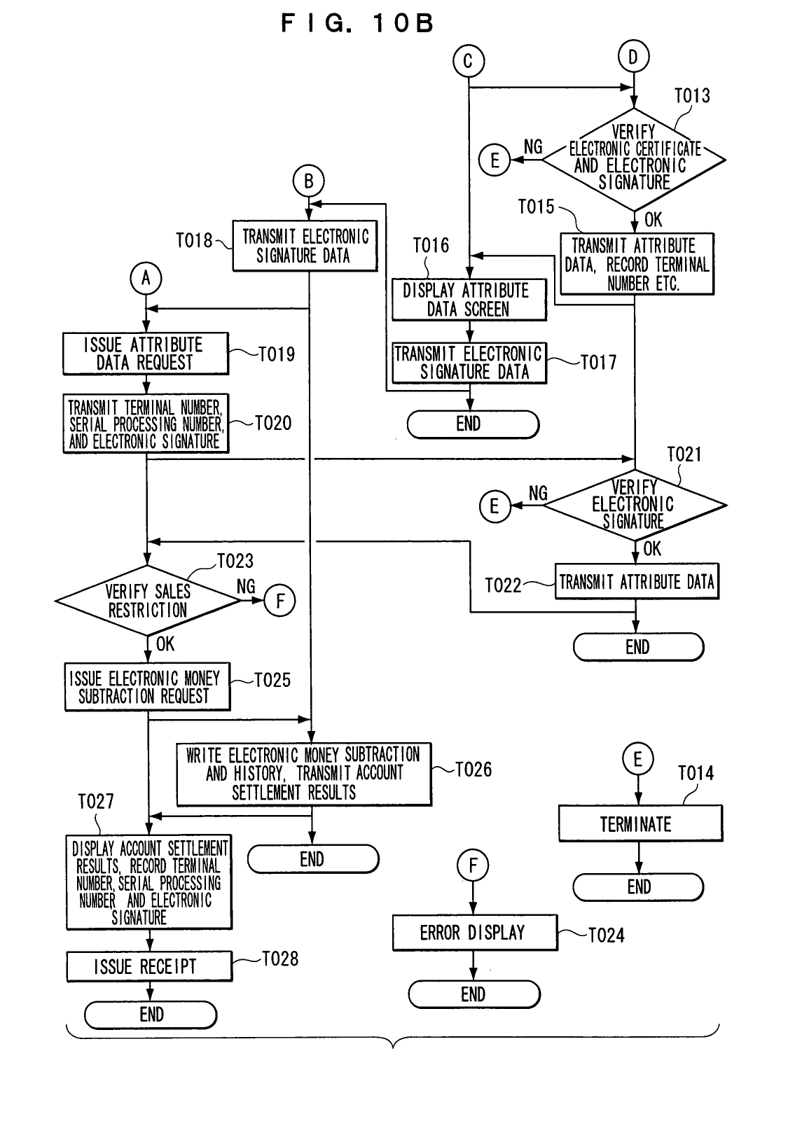

The processes of the processing in the present exemplary embodiment will be described next by using FIGS. 10A and 10B. FIGS. 10A and 10B are a flowchart showing the processes of the seller confirming the attribute information (name, age, address, and the like) of an individual and selling a good or service by electronic money, by using the electronic money account-settling terminal 101. The transmission and receipt of information, the confirmation of attribute information, and account settling are carried out among the electronic money account-settling terminal 101, the portable terminal 100, the non-contact IC card section 215 and the signature program 213 within the portable terminal 100, and an electronic signature verifying server 108 of an authenticating service provider. In the present exemplary embodiment, the electronic signature verifying server 108 is added to the first exemplary embodiment.

The seller operates the electronic money account-settling terminal 101, and inputs, to the electronic money account-settling terminal 101, the charged amount and a request for the necessary attribute information (e.g., date of birth, name) (step T001). The buyer sets the portable terminal 100 near the electronic money account-settling terminal 101 (step T002). Due to the portable terminal 100 being set near to the electronic money account-settling terminal 101, the electronic money account-settling terminal 101 transmits the terminal number of the electronic money account-settling terminal 101, the serial processing number, and the type of the attribute requested, to the portable terminal 100 (step T003). The non-contact IC card section 215 reads the signature key 307, the electronic certificate 308, and the subject password table 309 which are stored in the memory 216, from the memory 216 (step T004). Next, the non-contact IC card section 215 transmits, to the signature program 213, the terminal number, the serial processing number, the type of the attribute requested, the signature key 307, and the subject password table 309 (step T005). The signature program 213 compares the subject password table 309 and the requested attribute (e.g., date of birth), and reads the data of the password attribute of the identifier name “date of birth” in the subject password table 309. Then, signature program 213 advances the processing to step T010 if there is no password (i.e., if “none”), and advances the processing to step T007 if a password exists (step T006).

Next, the signature program 213 reads-out the data of the password input attribute in the subject password table 309, and if the password input attribute is “necessary”, advances processing to step T008, and, if the password input attribute is “unnecessary”, advances processing to step T010 (step T007). If password input is needed, the signature program 213 displays the identifier name of the attribute (e.g., date of birth) and a password input screen on the display device of the portable terminal 100, and the buyer inputs the corresponding password (step T008). The signature program 213 verifies whether the inputted password and the password of that attribute match (step T009). If, as the result of verification, the passwords match, the signature program 213 advances the processing on to step T010, whereas, if they do not match, the processing returns again to password input (step T008). After the password verification ends, the signature program 213 transmits the terminal number, the serial processing number, and the requested attribute type to the electronic signature verifying server 108 (step T010). The electronic signature verifying server 108 generates challenge data, such as the current time or the like, and transmits it to the signature program 213 (step T011). By using the signature key 307, the signature program 213 generates an electronic signature for the received challenge data and the terminal number, serial processing number, and requested attribute type, and transmits the electronic signature and the electronic certificate to the electronic signature verifying server 108 (step T012).

The electronic signature verifying server 108 verifies the valid period and the issuer of the received electronic certificate, and, after confirming that it is a legitimate electronic certificate, verifies the electronic signature for the challenge data and the terminal number, the serial processing number, and the requested attribute type, and verifies whether or not it is a legitimate signature (step T013). If it is a legitimate signature, the electronic signature verifying server 108 transmits, to the signature program 213, the attribute information (age or date of birth, address, or the like) corresponding to the requested attribute type of the member number listed in the subject of the electronic certificate (step T105). Simultaneously, the electronic signature verifying server 108 records the terminal number, the serial processing number, the requested attribute type, and the electronic certificate in a database 109 (step T015). If the electronic signature is not a legitimate signature, the signature program 213 terminates processing (step T014). The signature program 213 displays the received attribute information on the screen of the electronic money account-settling terminal 101, and the buyer confirms whether the contents are correct (step T016). The signature program 213 transmits the electronic signature to the non-contact IC card section 215 (step T017). Further, the non-contact IC card section 215 transmits the electronic signature to the electronic money account-settling terminal 101 (step T018). The electronic money account-settling terminal 101 issues an attribute data request to the electronic signature verifying server 108 (step T019).

The electronic money account-settling terminal 101 transmits the terminal number, the serial processing number, and the electronic signature to the electronic signature verifying server 108 (step T020). From the received terminal number and serial processing number, and on the basis of the challenge data, the requested attribute type, and the electronic certificate recorded in the database 109, the electronic signature verifying server 108 confirms whether the received electronic signature is legitimate (step T021). If it is a legitimate signature, the electronic signature verifying server 108 transmits, to the electronic money account-settling terminal 101, the attribute data which was transmitted to the signature program 213 in step T015 (step T022). If the electronic signature is not a legitimate signature, the signature program 213 terminates processing (step T014). The electronic money account-settling terminal 101 verifies the restrictions on the sale on the basis of the received attribute data. Specifically, in the case of a sale which is limited to those who are 20 years of age or older, from the attribute data of the date of birth and the current date, it is computed and verified that the buyer is 20 or older (step T023). The electronic money account-settling terminal 101 displays the results of verification of sales restrictions and the attribute information (the computed age, or the name and address), and if the sale is permissible, advances the processing on to step T025. If the sale is not permitted, the electronic money account-settling terminal 101 displays an error message and ends the account settlement (step T024).

Next, the electronic money account-settling terminal 101 issues, to the non-contact IC card section 215, an electronic money subtracting instruction for the charged amount inputted in step T001 (step T025). The non-contact IC card section 215 carries out subtraction processing of electronic money, updates the electronic money balance 305 and the usage history 306, and transmits the account settlement results to the electronic money account-settling terminal 101 (step T026). The electronic money account-settling terminal 101 displays the account settlement results on the screen, and records, in a secondary storage device, the results of the account settlement, the terminal number, the serial processing number, and the electronic signature (step T027). Finally, the electronic money account-settling terminal 101 issues a receipt and ends the account settlement (step T028).

After the account settlement, the seller transmits the terminal number, the serial processing number, and the electronic signature recorded in step T027 to the authenticating service provider, and can electronically prove to a third party whether or not the seller truly carried out attribute confirmation (age confirmation), and there is no need for the seller to retain the confirmed attribute information. Specifically, the authenticating service provider receives the terminal number, the serial processing number, and the electronic signature from the seller, and, from the terminal number and the serial processing number, reads-out the challenge data, the requested attribute type, and the electronic certificate from the database 109, and, by confirming that the electronic signature for the terminal number, the serial processing number and the challenge data is legitimate, can prove afterward that the attribute information was transferred to the seller from a legitimate buyer.

In accordance with the present invention, authentication of attributes such as age and the like, and identification of an individual such as the name and address or the like thereof, can be carried out by a portable device equipped with an electronic money function at a manned store or an unmanned store, without providing a document identifying the individual such as a driver's license or the like. Further, the buyer does not need to always carry a certificate such as a license or the like, and can prove his/her age and the like by using a cell phone or the like, and the convenience of use can be improved. Further, because the buyer can himself/herself set restrictions on information to be disclosed, there is no need to disclose information for which disclosure is not essentially needed, such as the date of birth or address or the like, and personal information can be protected.

Further, the seller can store, in the form of an electronic signature, the proof of confirmation of attributes and identification of an individual, and the need to make copies of licenses or the like can be eliminated. Moreover, the seller can store the proof of attribute confirmation and individual identification in an electronic signature which does not include personal information, and can verify the proof afterward, and it is easy to verify the legitimacy of the proof because alteration of the proof is difficult.

Preferred exemplary embodiments of the present invention have been described above with reference to the appended drawings, but the present invention is of course not limited to these examples. It will be apparent to those skilled in the art that various changed examples and modified examples can be conceived of within the scope put forth in the claims, and these changes and modifications are of course to be understood as falling within the technical scope of the present invention.

In accordance with an aspect of the present invention, there is provided a individual identifying/attribute authenticating system having: a portable terminal possessed by a buyer of a good or service; and an authenticating terminal set at a seller of the good or service, wherein the portable terminal includes: a storage component storing an electronic certificate, which lists attribute information of the buyer, and a signature key which are issued by an electronic authenticating service system; a component generating an electronic signature by using the signature key; and a component transmitting the electronic certificate and the electronic signature to the authenticating terminal, and the authenticating terminal includes: a component receiving the electronic certificate and the electronic signature from the portable terminal; a component judging whether or not the electronic signature is legitimate, in accordance with whether or not the electronic signature was generated by the signature key corresponding to a signature verifying key listed in the electronic certificate; a component acquiring the attribute information listed in the electronic certificate, in a case in which the electronic signature is legitimate; and a component judging whether or not the attribute information satisfies a sales restricting condition of the good or service.

In accordance with this structure, an electronic certificate in which attribute information is listed and a signature key are stored in, for example, a portable terminal equipped with an electronic money function. By transmitting an electronic certificate and an electronic signature, which are generated within that terminal, to an electronic money account-settling terminal, the electronic money account-settling terminal electronically verifies the electronic certificate and the electronic signature, obtains highly-accurate attribute information (the age or the like) and individual identification (the name or the like) of the buyer, and thereafter, carries out electronic money account settlement.

Further, due to an authenticating service provider storing the attribute information of the buyer in the electronic certificate for that buyer, individual identification and attribute authentication can be carried out even at a portable terminal which does not store an electronic certificate and an account-settling terminal which is not connected to a network. Further, usage for only individual identification and age confirmation, which does not accompany an electronic money account settlement, also is possible.

The authenticating service provider issues the electronic certificate which stores plural attribute information. At this time, the attribute information can be listed in the electronic certificate such that some of the attribute information is in an encrypted form which can be decrypted by input of passwords which are set for the respective attribute information. Further, the passwords may be further stored in the storage component of the portable terminal, and the portable terminal may further include a component which transmits the passwords to the authenticating terminal, and the authenticating terminal may further include a component receiving the passwords from the portable terminal, and a component which, in a case in which the electronic signature is legitimate, decrypts the encrypted attribute information included in the electronic certificate by using the passwords. Moreover, the portable terminal may further have a component which, before transmission of the attribute information from the portable terminal to the authenticating terminal, sets, for each of the attribute information, whether or not input of a password is required when the attribute information is transmitted from the portable terminal to the authenticating terminal. The buyer transmits the password, which is the decryption key of the attribute information that he/she wishes to disclose to the seller, from the portable terminal to the account-settling terminal of the buyer. In accordance with this structure, it is possible to provide to the seller only the attribute information which is needed for the purchase. Protection of privacy and personal information can thereby be carried out.

It is possible for the above-described authenticating terminal to not be connected to a communication network, and to receive the electronic certificate by a non-contact communication method from a non-contact IC card section which serves as the component of the portable terminal which transmits the electronic certificate. In accordance with this structure, the authenticating terminal can receive, by a non-contact method, the electronic certificate which is stored in the portable terminal. Therefore, individual identification and attribute authentication can be carried out even at an authenticating terminal which is not connected to a network.

The electronic money account-settling terminal may further include a component which records the attribute information and the electronic certificate. In accordance with this structure, the seller stores the results of authenticating the attribute of an individual as evidence of inspecting the electronic signature data issued by the signature key which the buyer has. In this way, the seller can prove, after the sale and by using this electronic signature, that attribute authentication was carried out electronically. Then, the seller electronically stores the evidence of the confirmation of the attributes and the identification of the individual, and can prove afterwards that confirmation was carried out. Therefore, it suffices for the seller to not acquire and store copies of documents identifying individuals.

In accordance with another aspect of the present invention, there is provided an individual identifying/attribute authenticating system having: a portable terminal possessed by a buyer of a good or service; an authenticating terminal set at a seller of the good or service; and an electronic authenticating service system connected to the authenticating terminal and the portable terminal via a communication network, wherein the portable terminal includes: a storage component storing an electronic certificate, in which an identification number of the buyer is recorded, and a signature key which are issued by the electronic authenticating service system; a component transmitting the electronic certificate to the electronic authenticating service system; a component generating an electronic signature by using the signature key; and a component transmitting the electronic signature to the authenticating terminal, and the electronic authenticating service system includes: a database in which attribute information of the buyer is recorded; a component receiving the electronic certificate from the portable terminal; a component receiving the electronic signature from the authenticating terminal; a component judging whether or not the electronic signature is legitimate, in accordance with whether or not the electronic signature was generated by the signature key corresponding to a signature verifying key listed in the electronic certificate; and a component which, in a case in which the electronic signature is legitimate, transmits, to the authenticating terminal, the attribute information which is recorded in the database and which corresponds to the identification number listed in the electronic certificate, and the authenticating terminal includes: a component receiving the electronic signature from the portable terminal; a component transmitting the electronic signature to the electronic authenticating service system; a component receiving the attribute information from the electronic authenticating service system; and a component judging whether or not the attribute information satisfies a sales restricting condition of the good or service.

In accordance with this structure, the authenticating service provider of the member number records only a number identifying the individual in the electronic certificate. Without storing the attribute information in the certificate, the authenticating service provider identifies the buyer from the electronic signature which the buyer issued, and can provide the latest attribute information of individuals stored in an electronic authenticating service computer, to sellers via a network.

Some of the plural attribute information recorded in the database can be stored in the database in an encrypted form which can be decrypted by input of passwords corresponding to the respective attribute information. Further, the electronic authenticating service system may further include a component which, before transmission of the attribute information from the electronic authenticating service system to the authenticating terminal, sets, for each of the attribute information, whether or not input of a password is required when the attribute information is transmitted from the electronic authenticating service system to the authenticating terminal. In accordance with this structure, it is possible to provide to the seller only the attribute information which is needed for the purchase. Protection of privacy and personal information can thereby be carried out.

In accordance with the present invention, at the time of settling accounts by using electronic money, when selling goods or services requiring confirmation of age or identification of an individual, a seller can carry out confirmation of the attributes of the buyer and identification of the buyer, without the buyer providing a document such as a driver's license or the like.

What is claimed is:

1. An individual identifying/attribute authenticating system comprising:
a portable terminal possessed by a buyer of a good or service; and
an authenticating terminal set at a seller of the good or service,
wherein the portable terminal includes:
a storage component storing an electronic certificate, which lists attribute information of the buyer, and a signature key which are issued by an electronic authenticating service system;
a component generating an electronic signature by using the signature key; and
a component transmitting the electronic certificate and the electronic signature to the authenticating terminal, and
the authenticating terminal includes:
a component receiving the electronic certificate and the electronic signature from the portable terminal;
a component judging whether or not the electronic signature is legitimate, in accordance with whether or not the electronic signature was generated by the signature key corresponding to a signature verifying key listed in the electronic certificate;
a component acquiring the attribute information listed in the electronic certificate, in a case in which the electronic signature is legitimate; and
a component judging whether or not the attribute information satisfies a sales restricting condition of the good or service.

2. The individual identifying/attribute authenticating system of claim 1, wherein some of the attribute information listed in the electronic certificate are stored in the storage component of the portable terminal in an encrypted form which can be decrypted by input of passwords corresponding to the respective attribute information.

3. The individual identifying/attribute authenticating system of claim 2, wherein
the passwords are further stored in the storage component of the portable terminal,
the portable terminal further includes a component which transmits the passwords to the authenticating terminal, and
the authenticating terminal further includes:
a component receiving the passwords from the portable terminal; and
a component which, in a case in which the electronic signature is legitimate, decrypts the encrypted attribute information included in the electronic certificate by using the passwords.

4. The individual identifying/attribute authenticating system of claim 3, wherein the portable terminal further has a component which, before transmission of the attribute information from the portable terminal to the authenticating terminal, sets, for each of the attribute information, whether or not input of a password is required when the attribute information is transmitted from the portable terminal to the authenticating terminal.

5. The individual identifying/attribute authenticating system of claim 1, wherein the authenticating terminal is not connected to a communication network, and receives the electronic certificate by a non-contact communication method from a non-contact IC card section which serves as the component of the portable terminal which transmits the electronic certificate.

6. The individual identifying/attribute authenticating system of claim 1, wherein the authenticating terminal further includes a recording component recording the electronic certificate and the electronic signature.

7. An individual identifying/attribute authenticating system comprising:
a portable terminal possessed by a buyer of a good or service;
an authenticating terminal set at a seller of the good or service; and
an electronic authenticating service system connected to the authenticating terminal and the portable terminal via a communication network,
wherein the portable terminal includes:
a storage component storing an electronic certificate, in which an identification number of the buyer is recorded, and a signature key which are issued by the electronic authenticating service system;
a component transmitting the electronic certificate to the electronic authenticating service system;
a component generating an electronic signature by using the signature key; and
a component transmitting the electronic signature to the authenticating terminal, and
the electronic authenticating service system includes:
a database in which attribute information of the buyer is recorded;
a component receiving the electronic certificate from the portable terminal;
a component receiving the electronic signature from the authenticating terminal;
a component judging whether or not the electronic signature is legitimate, in accordance with whether or not the electronic signature was generated by the signature key corresponding to a signature verifying key listed in the electronic certificate; and
a component which, in a case in which the electronic signature is legitimate, transmits, to the authenticating terminal, the attribute information which is recorded in the database and which corresponds to the identification number listed in the electronic certificate, and
the authenticating terminal includes:
a component receiving the electronic signature from the portable terminal;
a component transmitting the electronic signature to the electronic authenticating service system;
a component receiving the attribute information from the electronic authenticating service system; and
a component judging whether or not the attribute information satisfies a sales restricting condition of the good or service.

8. The individual identifying/attribute authenticating system of claim 7, wherein some of the plurality of attribute information recorded in the database are stored in the database in an encrypted form which can be decrypted by input of passwords corresponding to the respective attribute information.

9. The individual identifying/attribute authenticating system of claim 8, wherein the electronic authenticating service system further has a component which, before transmission of the attribute information from the electronic authenticating service system to the authenticating terminal, sets, for each of the attribute information, whether or not input of a password is required when the attribute information is transmitted from the electronic authenticating service system to the authenticating terminal.

10. An individual identifying/attribute authenticating method executed by a portable terminal possessed by a buyer of a good or service, and an authenticating terminal set at a seller of the good or service, the method comprising:
the portable terminal storing, in a storage section, an electronic certificate, which lists attribute information of the buyer, and a signature key which are issued by an electronic authenticating service system;
the portable terminal generating an electronic signature by using the signature key;
the portable terminal transmitting the electronic certificate and the electronic signature to the authenticating terminal;
the authenticating terminal receiving the electronic certificate and the electronic signature from the portable terminal;
the authenticating terminal judging whether or not the electronic signature is legitimate, in accordance with whether or not the electronic signature was generated by the signature key corresponding to a signature verifying key listed in the electronic certificate;
the authenticating terminal acquiring the attribute information listed in the electronic certificate, in a case in which the electronic signature is legitimate; and
the authenticating terminal judging whether or not the attribute information satisfies a sales restricting condition of the good or service.

11. An individual identifying/attribute authenticating method executed by a portable terminal possessed by a buyer of a good or service, an authenticating terminal set at a seller of the good or service, and an electronic authenticating service system connected to the authenticating terminal and the portable terminal via a communication network, the method comprising:
the electronic authenticating service system recording attribute information of the buyer in a database;
the portable terminal storing, in a storage section, an electronic certificate, in which an identification number of the buyer is recorded, and a signature key which are issued by the electronic authenticating service system;
the portable terminal transmitting the electronic certificate to the electronic authenticating service system;
the electronic authenticating service system receiving the electronic certificate from the portable terminal;
the portable terminal generating an electronic signature by using the signature key;
the portable terminal transmitting the electronic signature to the authenticating terminal;
the authenticating terminal receiving the electronic signature from the portable terminal;
the authenticating terminal transmitting the electronic signature to the electronic authenticating service system;
the electronic authenticating service system receiving the electronic signature from the authenticating terminal;
the electronic authenticating service system judging whether or not the electronic signature is legitimate, in accordance with whether or not the electronic signature was generated by the signature key corresponding to a signature verifying key listed in the electronic certificate;
in a case in which the electronic signature is legitimate, the electronic authenticating service system transmitting, to the authenticating terminal, the attribute information which is recorded in the database and which corresponds to the identification number listed in the electronic certificate;
the authenticating terminal receiving the attribute information from the electronic authenticating service system; and
the authenticating terminal judging whether or not the attribute information satisfies a sales restricting condition of the good or service.
